(19) United States
(12) Patent Application Publication
(10) Pub. No.: US 2008/0210850 A1
(43) Pub. Date: Sep. 4, 2008

(54) Light receiving module

(75) Inventor: Akira Obika, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 11/903,736

(22) Filed: Sep. 24, 2007

(30) Foreign Application Priority Data
Sep. 22, 2006 (JP) 2006-257085

(51) Int. Cl. G01J 1/04

(52) U.S. Cl. 250/216

(57) ABSTRACT

A light receiving module includes a substrate, a light receiving element mounted on the substrate, and a resin package for covering the light receiving element. The top portion of the resin package is formed with a lens for collecting external light to the light receiving element. The lens includes a light incident surface formed with irregularities for light dispersion. The light receiving module further includes a tubular body accommodated in the resin package. The tubular body is tapered as proceeding toward the light receiving element, and has an inner surface for light reflection. Light collected by the lens is reflected by the inner surface of the tubular body, to be detected by the light receiving element.

### BACKGROUND OF THE INVENTION

1. Field of the Invention

The present invention relates to a light receiving module used for optical communication.

2. Description of the Related Art

In optical communication, light is used as a communication medium, for transmitting a large amount of information at high-speed. An optical communication system includes a light emitting module as a light source and a light receiving module for detecting light emitted by the light emitting module. Examples of conventional light emitting module and light receiving module are disclosed in JP-A-2005-17678. FIG. 5 in this document illustrates a light emitting module provided with a convex lens for collecting light.

FIG. 10 of the present application illustrates a light receiving module as a reference example for better understanding of the technique according to the present invention. The illustrated light receiving module X includes a substrate 91, a photodiode 92 mounted on the substrate 91, and a resin package 93 covering the photodiode 92. The resin package 93 is formed with a lens 93a for collecting light to the photodiode 92. The lens 93a is a convex lens and focuses light entering from the outside on the photodiode 92 (see solid lines shown in FIG. 10).

The above light receiving module leaves room for improvement in the following points. Recently, as a way of increasing communication speed, a photodiode of the light receiving module has been downsized and thus a light receiving surface of the photodiode has been reduced. However, when the light receiving surface of the photodiode is small, focused light may not arrive at the light receiving surface. For example, as shown by phantom lines in FIG. 10, if light enters into the resin package 93 from a portion deviating to the right, the focused light also deviates from a light receiving surface 92a of the photodiode 92. Thus, with the structure shown in FIG. 10, depending on the position from which light enters into the resin package 93, the photodiode 92 may not properly receive the light, resulting in communication trouble.

### SUMMARY OF THE INVENTION

The present invention has been proposed under the above-described circumstances. It is therefore an object of the present invention to provide a light receiving module capable of reliably detecting light which carries information.

A light receiving module according to the present invention comprises a light receiving element and a resin package for covering the light receiving element, the resin package being formed with a lens for collecting light to the light receiving element. The resin package includes a surface serving as a boundary between substances of different refractive indexes, the surface being formed with irregularities. Here, “substances of different refractive indexes” are typically the lens and the air surrounding the lens. When the resin package includes a plurality of layers made of different materials, the “substances” are one of the layers and another held in contact with the first layer.

Preferably, the irregularities are rotationally symmetric with respect to a light axis of the lens. The surface with such irregularities is obtained by rotating one of a sinusoidal waveform, a-triangular waveform and a trapezoidal waveform around the light axis.

Preferably, the light receiving module according to the present invention further comprises a tubular body which is positioned between the lens and the light receiving element and is tapered as proceeding toward the light receiving element. The tubular body includes a tapered inner surface for guiding light collected by the lens to the light receiving element, and also includes an opening near the lens which is larger than a light receiving surface of the light receiving element.

Other features and advantages of the present invention will be apparent from the following description with reference to the accompanying drawings.

### BRIEF DESCRIPTION OF THE DRAWINGS

FIG. 1 is a sectional view illustrating a light receiving module according to a first embodiment of the present invention.

FIG. 2 is a graph illustrating the difference between the light receiving module of FIG. 1 and a comparative example.

FIG. 3 is a sectional view illustrating a light receiving module according to a second embodiment of the present invention.

FIG. 4 is a sectional view illustrating a light receiving-module according to a third embodiment of the present invention.

FIG. 5 is a sectional view illustrating a light receiving module according to a fourth embodiment of the present invention.

FIGS. 6A-6D illustrate examples of irregularities formed on a lens.

FIG. 7 is a sectional view illustrating a light receiving module according to a fifth embodiment of the present invention.

FIG. 8 is a sectional view illustrating a light receiving module according to a sixth embodiment of the present invention.

FIG. 9 is a graph illustrating a difference between the light receiving module of FIG. 8 and a comparative example.

FIG. 10 is a sectional view illustrating a light receiving module as a reference example.

### DESCRIPTION OF THE PREFERRED EMBODIMENTS

Preferred embodiments of the present invention will be described below with reference to the accompanied drawings.

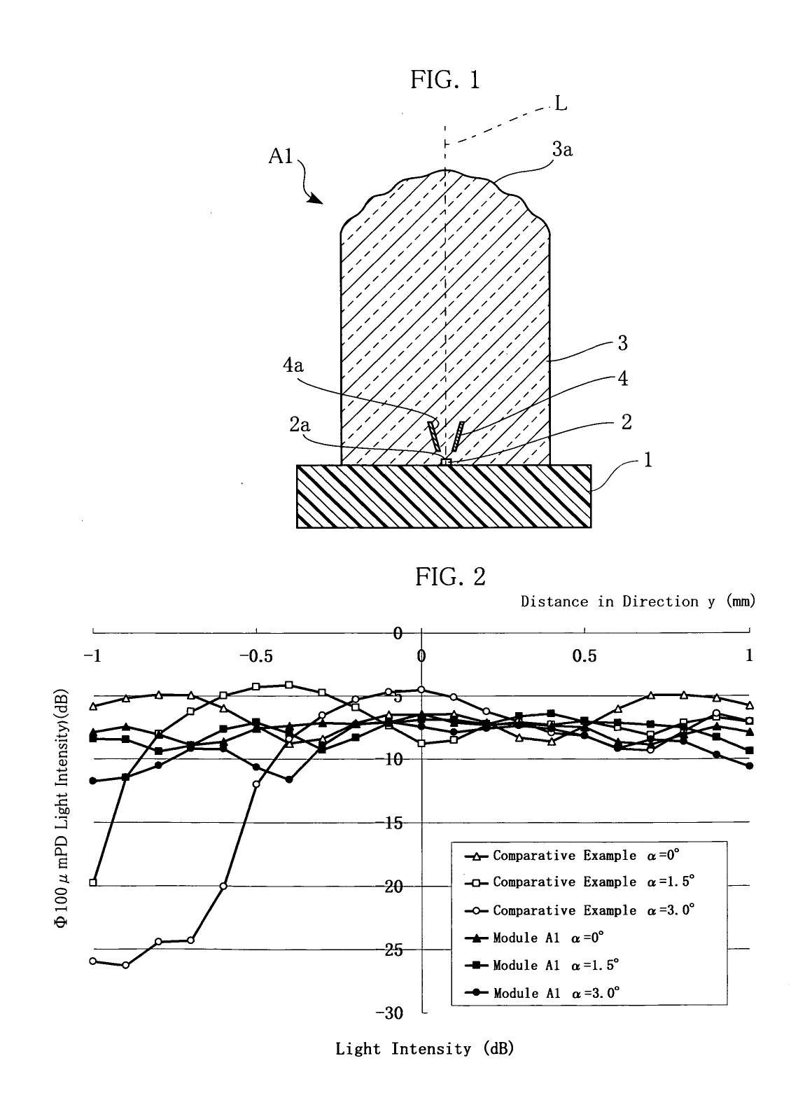

FIG. 1 illustrates a light receiving module according to a first embodiment of the present invention. The illustrated light receiving module A1 includes a substrate 1, a photodiode 2, a resin package 3, and a tubular body 4. The light receiving module A1 works together with a light emitting module (not shown) for transmitting information, with the photodiode 2 used for receiving the light emitted from the light emitting module.

The photodiode 2 and the resin package 3 are provided on the substrate 1.

The photodiode 2 generates electrical current corresponding to the amount of the received light. The photodiode 2 includes a light receiving surface 2a having a diameter of about 100 μm, for example. The photodiode 2 is located on a light axis. L so as to properly receive light transmitted through a lens 3a.

The resin package 3 is made of a resin material that permits the passage of light emitted from the light emitting module, and covers the photodiode 2. The upper surface of the resin package 3 (i.e. the boundary surface with the air) serves as the lens 3a which is convex as a whole and has an undulating surface. As viewed in plan, the lens 3a has a diameter of about 3.3 mm. The lens 3a is formed with irregularities obtained by rotating a sinusoidal curve around the light axis L. The undulating form of the lens 3a may be defined by the following Formula 1 in a cylindrical coordinate system. The sixth term of Formula 1 represents a sine wave, H represents the amplitude of the sine wave (H=0.01 mm, for example), and WL represents the wavelength of the sine wave (WL=0.5 mm, for example).

$$f = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + H \times cos \frac{2 r}{WL} - z \qquad ( 1 )$$

where r²=x²+y².

The resin package 3 accommodates the tubular body 4. The tubular body 4 is made of a metal, for example, and positioned between the photodiode 2 and the lens 3a, near the photodiode 2. The tubular body 4 surrounds the light axis L, and has an inner diameter becoming smaller as proceeding toward the photodiode 2. In other words, the tubular body 4 is tapered as proceeding toward the photodiode 2. The tubular body 4 includes an inner surface 4a which is a tapered surface for reflecting light to be received by the photodiode 2. The tubular body 4 includes a lower opening (opening at the side of the photodiode 2) with a diameter the same as that of the light receiving surface 2a of the photodiode 2, and an upper opening (opening at the side of the lens 3a) with a diameter larger than that of the light receiving surface 2a. With such structure, light enters from the relatively wider upper opening and is repeatedly reflected by the tapered inner surface 4a, and then emitted out from the opening as large as the light receiving surface 2a, toward the light receiving surface 2a (As can be easily understood, part of light is not reflected by the tapered inner surface 4a, and is directly emitted toward the light receiving surface 2a). In this way, with the tapered inner surface 4a, light is collected from an area larger than the light receiving surface 2a, so that light entering into the light receiving surface 2a is increased.

Next, the functions of the light receiving module A1 will be described.

In the light receiving module A1, the lens 3a is formed with irregularities. Thus, incident light is collected by the lens 3a and is suitably dispersed by the irregularities. This dispersion enlarges the area of light irradiation to the photodiode 2. Here, the tapered inner surface 4a of the tubular body 4 is capable of guiding light from a relatively wide area to the photodiode 2. Therefore, the light receiving module A1 has a high light sensitivity. Description will be made below with reference to specific embodiments.

FIG. 2 is a graph showing the light sensitivity of each of the light receiving module A1 and a comparative example having a structure similar to that of the light receiving module A1. In the comparative example of the light receiving module, the lens is formed with no irregularities, similarly to the light receiving module X shown in FIG. 10, and the other structures are the same as those of the light receiving module A1. In the graph shown in FIG. 2, intensity of incident light at the photodiode is indicated on the longitudinal axis, and distance from the light axis L, which is the light incident position into the lens, is indicated on the horizontal axis. Further in the graph shown in FIG. 2, the lateral direction in FIG. 1 is indicated as direction y, and the origin of the y-coordinate corresponds to the position of the light axis L. Still further, in the graph shown in FIG. 2, three lines with respect to three kinds of incident angles α are shown for each of the light receiving module A1 and the comparative example. Each of the incident angles α indicates the angle between the light axis L and incident light.

As can be seen from FIG. 2, in the comparative examples, when the incident angle α is 1.5° or 3.0° and the position in the direction y is −1, the light intensity at the photodiode is largely reduced. On the other hand, in the light receiving module A1, the light intensity is not largely reduced at any point. This indicates that the light receiving module A1 is capable of stably receiving light at any light incident position, due to the irregularities formed at the lens 3a.

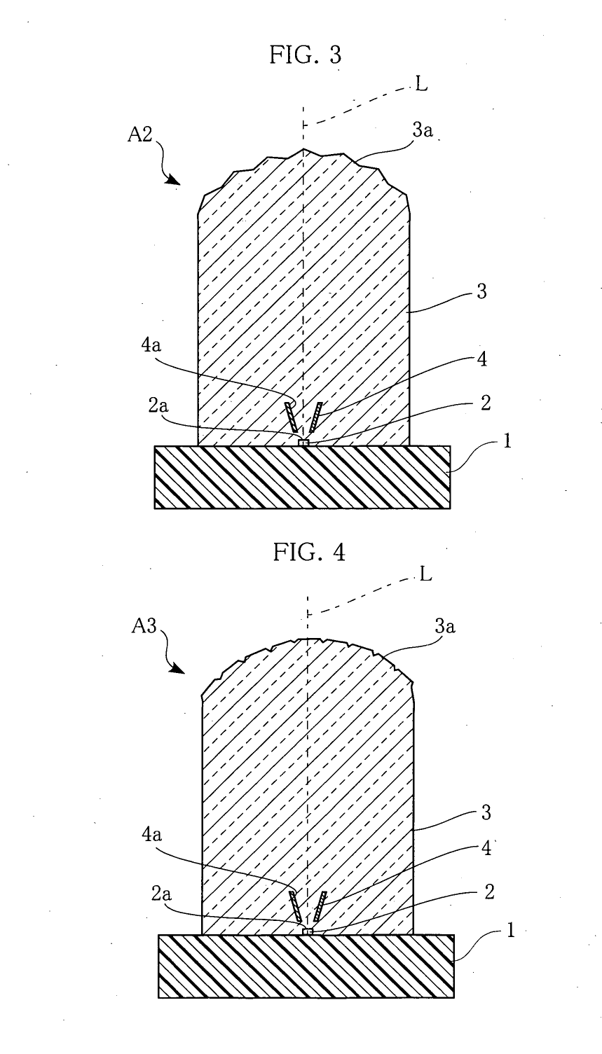

FIG. 3 illustrates a light receiving module according to a second embodiment of the present invention. The light receiving module A2 in the figure includes a lens 3a formed with irregularities obtained by rotating a triangular waveform, and the other structures are the same as those of the light receiving module A1.

Even the irregularities of the lens 3a are in such form of triangular waves, incident light is dispersed so that irradiated area on the light receiving surface 2a is increased. Thus, the light receiving module A2 has a high light receiving sensitivity. Further, since the irregularities on the surface of the light receiving module A2 are an aggregate of plan surfaces, forming of the lens 3a is easier than that of the light receiving module A1.

FIG. 4 illustrates a light receiving module according to a third embodiment of the present invention. The illustrated light receiving module A3 includes a lens 3a formed with irregularities obtained by rotating a trapezoidal waveform, and the other structures are the same as those of the light receiving modules A1, A2.

Even the irregularities of the lens 3a are in such form of trapezoidal waves, incident light is dispersed so that irradiated area on the light receiving surface 2a is increased. Thus, the light receiving module A3 has a high light receiving sensitivity. Further, since the irregularities on the surface of the light receiving module A3 are an aggregate of plan surfaces, forming of the lens 3a is easier than that of the light receiving module A1.

FIG. 5 illustrates a light receiving module according to a fourth embodiment of the present invention. In the light receiving module A4 shown in FIG. 5, a resin package 3, which is a simple body in the light receiving module A1, includes a lens layer 5, an external frame 6, and a protection layer 7. The lens layer 5 is formed of a transparent resin, and includes a lens 3a projecting upward in FIG. 5. The lens 3a is, similarly to the light receiving module A1, formed with irregularities obtained by rotating a sinusoidal waveform. The external frame 6 is a cylindrical resin package mounted on the protection layer 7, and supports the lens layer 5. The external frame 6 accommodates an air layer 6a. The protection layer 7 is made of a transparent resin, and protects the photodiode 2 and the substrate 1, while supporting the tubular body 4. Other structures of the light receiving module A4 is the same as those of the light receiving module A1.

In the light receiving module A4, similarly to the light receiving module A1, incident light is dispersed by the irregularities formed on the lens 3a, so that irradiated area on the photodiode 2 is increased. Thus, the light receiving module A4 is capable of receiving light stably, similarly to the light receiving module A1. Further, by setting the refractive index of the lens layer 5 to be larger than that of the air layer 6a, light entered from the lens 3a is refracted between the lens layer 5 and the air layer 6a, in a manner such that the focal position of the lens 3a becomes closer to the lens 3a. Thus, in the light receiving module A4, incident light is focused at a distance shorter than that of the light receiving module A1, which contributes to downsize the module.

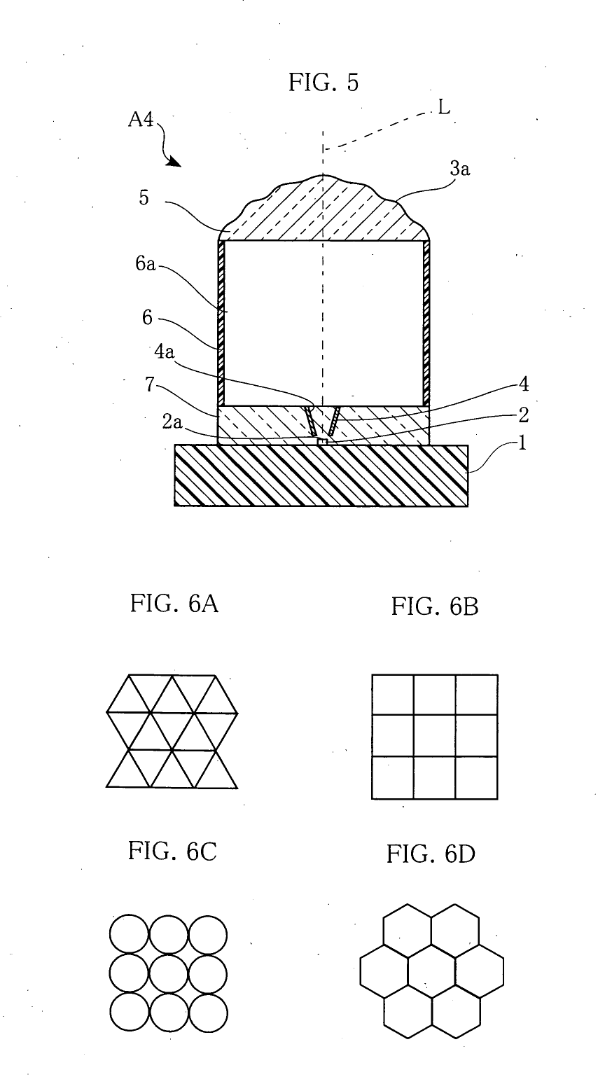

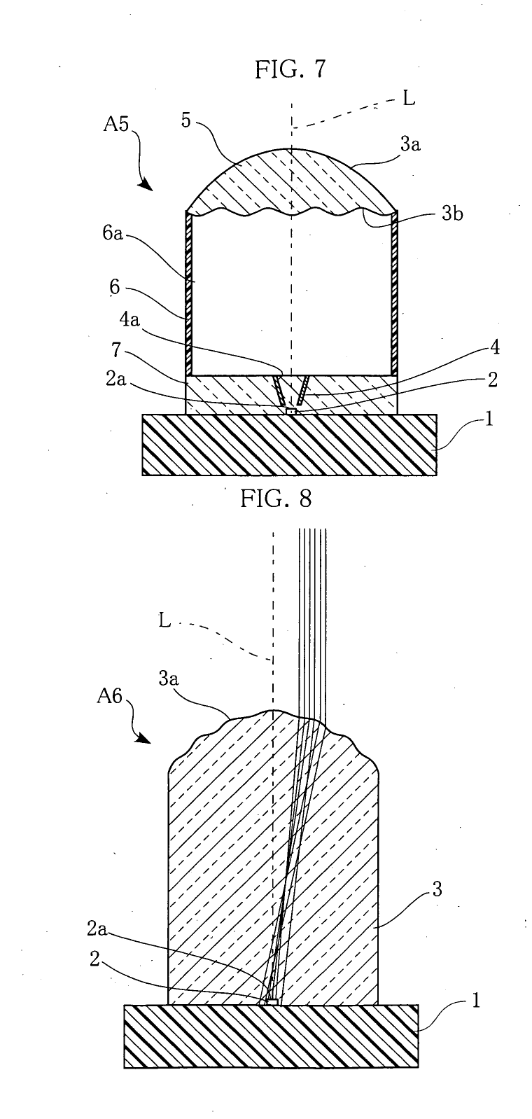

In the above-described embodiments, the lens 3a is formed with wavy irregularities, however, may be formed with polygonal or circular irregularities as shown in FIGS. 6A-6D, as viewed in the direction of the light axis L. In other words, the surface of the lens 3a may be formed with irregularities of polygonal cones, polygonal frustums, circular cones, or circular frustums. Even with such irregularities, incident light is dispersed.

FIG. 7 illustrates a light receiving module according to a fifth embodiment of the present invention. The illustrated light receiving module A5 is formed with irregularities at the lower surface of the lens layer 5 (a reverse surface 3b of the lens 3a), and the other structures are the same as those of the light-receiving module A4. The lens layer Sand the air layer 6a have different refractive indexes, and the reverse surface 3b of the lens 3a serves as the boundary surface of the layers.

When light entering from the lens 3a and traveling toward the photodiode 2 passes through the reverse surface 3b, the light is dispersed by the irregularities formed on the reverse surface 3b. Thus, irradiated area on the light receiving surface 2a is increased, whereby the light receiving module A5 has a high light receiving sensitivity. Further, since it is easier to form irregularities on the reverse surface 3b which is a plan surface, than to form irregularities on the curved surface of the lens 3a, manufacture of the light receiving module A5 is easier than that of the light receiving module A4. The irregularities on the reverse surface 3b are not limited to have the sinusoidal waveform, but the forms described in the above embodiments may be applied.

FIG. 8 illustrates a light receiving module according to a sixth embodiment of the present invention. The illustrated light receiving module A6 has the same structure as the light receiving module A1 except that the tubular body 4 is omitted. With such structure, light is not collected from a large area as in the light receiving module A1, however, steps for forming the tubular body 4 are saved. In such light receiving module A6, as shown by solid lines in the figure, even light entered from a position apart from the light axis L arrives to the light receiving surface 2a due to dispersion at the lens 3a. Description is made below with reference to examples.

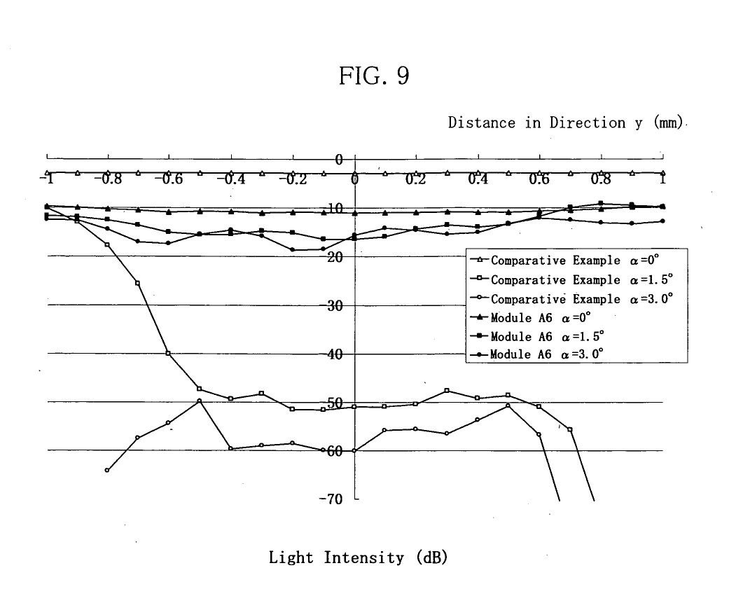

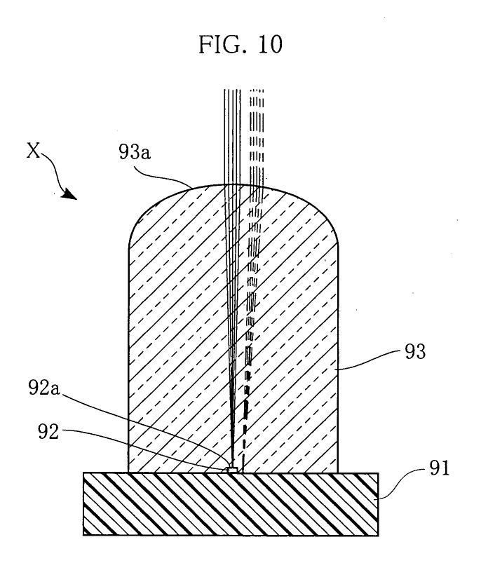

FIG. 9 shows a difference between the light sensitivities of the light receiving module A6 and a comparative example having similar structures. The comparative light receiving module includes a lens without irregularities as the light receiving module X, and the other structures are the same as those of the light receiving module A6.

As shown in FIG. 9, in the comparative example, the light intensity is relatively low when the incident angle α is not 0°. In the light receiving module A6, the light intensity is stably high, regardless of the incident angle and the position in the direction y. In other words, even when the light enters at a certain angle with respect to the light axis L, or enters from a position apart from the position immediately above the photodiode 2a, as seen in the figure, the light receiving module A6 has a high light sensitivity.

1. A light receiving module comprising:
a light receiving element; and
a resin package for covering the light receiving element, the resin package being formed with a lens for collecting light to the light receiving element;
wherein the resin package includes a surface serving as a boundary between substances of different refractive indexes and formed with irregularities.

2. The light receiving module according to claim 1, wherein the irregularities are rotationally symmetric with respect to a light axis of the lens.

3. The light receiving module according to claim 2, wherein the irregularities are obtained by rotating one of a sinusoidal waveform, a triangular waveform and a trapezoidal waveform around the light axis.

4. The light receiving module according to claim 1, further comprises a tubular body which is positioned between the lens and the light receiving element and is tapered as proceeding toward the light receiving element, the tubular body including a tapered inner surface for guiding light collected by the lens to the light receiving element, the tubular body also including an opening near the lens, the opening being larger than a light receiving surface of the light receiving element.
